(19) United States
(12) Patent Application Publication
(10) Pub. No.: US 2006/0140652 A1
(43) Pub. Date: Jun. 29, 2006

(54) Developer device and image forming apparatus

(75) Inventor: Nao Itabashi, Nagoya-shi (JP)

Correspondence Address: BANNER & WITCOFF, LTD.;ATTORNEYS FOR CLIENT NOS. 0166889, 006760, 1001 G STREET, N.W., 11TH FLOOR, WASHINGTON, DC, 20001-4597, US

(73) Assignee: Brother Kogyo Kabushiki Kaisha, Nagoya-shi (JP)

(21) Appl. No.: 11/316,870

(22) Filed: Dec. 27, 2005

(30) Foreign Application Priority Data
Dec. 27, 2004 (JP) JP2004377485

(51) Int. Cl. G03G 15/08

(52) U.S. Cl. 399/27; 399/106

(57) ABSTRACT

A laser printer is configured so that a process unit having a developing cartridge is detachably attachable to an apparatus body. A frame of the developing cartridge is formed with a toner chamber storing toner and a toner inlet that communicates with the toner chamber. A capping member is either permanently or detachably attachable with respect to the toner inlet. The capping member is provided with a light-transmitting portion through which light transmits to detect the toner level.

### CROSS REFERENCE TO RELATED APPLICATION

This application claims priority from Japanese Patent Application No. 2004-377485, filed on Dec. 27, 2004, the entire subject matter of which is incorporated herein by reference.

### TECHNICAL FIELD

Aspects of the invention relate to a developer device and an image forming apparatus.

### BACKGROUND

Conventionally, an image forming apparatus such as a laser printer is provided with a structure for detecting the remaining amount of toner stored in a toner accommodating portion. For example, Japanese Laid-Open Patent Application No. 2004-118093 discloses a structure for detecting the remaining amount of toner by shining light in a toner accommodating portion via a remaining amount detecting window (a light transmitting window) 84, which is provided on a frame of the toner accommodating portion, and receiving the light at a light receiving portion.

In the above image forming apparatus, a structure having a toner inlet is provided for toner refill (when the amount of remaining toner is low) is widely used. For example, Japanese Laid-Open Patent Application No. 2004-118093 discloses a structure in which a toner injecting through-hole 82 is formed on a left sidewall 55 of a toner accommodating chamber 76 and a capping member 88 is detachably attached to the toner injecting through-hole 82.

However, a conventional image forming apparatus, such as described above, is provided with a remaining toner detection window 84 (for detecting a remaining amount of toner) and a toner injecting through-hole 82 for a toner refill, which are located independently in different positions. This has the effect of increasing the size of the image forming apparatus. Additionally, as the windows and their corresponding detecting systems are provided in isolation, the number of parts increases, thereby complicating assembly of the image forming apparatus.

### SUMMARY

Aspects of the invention provide a developer device and an image forming apparatus for use with the developer device having a structure that enables both of remaining toner detection and a toner refill, thereby reducing the size of the systems to perform these functions and reducing the number of parts needed for assembly and/or maintenance.

### BRIEF DESCRIPTION OF THE DRAWINGS

Illustrative embodiments of the invention will be described in detail with reference to the following figures wherein:

FIG. 1 is a side sectional view of a general structure of a laser printer as an image forming apparatus according to a first embodiment of the invention;

FIG. 2 is an enlarged side sectional view of a developer unit in accordance with aspects of the present invention;

FIG. 3 is a sectional view showing an inside of a toner chamber in accordance with aspects of the present invention;

FIG. 4 is a side view of a developing cartridge unit in accordance with aspects of the present invention;

FIG. 5 is a sectional view of a toner inlet taken along the line V-V of FIG. 4 unit in accordance with aspects of the present invention;

FIG. 6 schematically shows a drive system of the developing cartridge unit in accordance with aspects of the present invention; and

FIG. 7 shows a toner inlet of an image forming apparatus according to a second embodiment, which is a modification of a capping member shown in FIG. 5, unit in accordance with aspects of the present invention.

### DETAILED DESCRIPTION

It is noted that various connections are set forth between elements in the following description. It is noted that these connections in general and, unless specified otherwise, may be direct or indirect and that this specification is not intended to be limiting in this respect.

<General Overview>

According to an aspect of the invention, a developer unit may include an accommodating flame having a toner storing portion capable of storing toner and a toner inlet communicating with the toner storing portion; and a capping member provided to be detachably attachable to the accommodating flame. The capping member may be attached to the accommodating flame to close the toner inlet and have a light-transmitting portion. The capping member may be at least translucent (including but not limited to being transparent).

The capping member can be functioned as a window for detecting toner level, there is no need to individually provide a light-transmitting part for detecting the toner level and a removable part for entering toner. In addition, the accommodating frame does not need working in each time for mounting such parts. Thus, space for layout can be omitted, and the number of parts can be reduced.

According to an aspect of the invention, the accommodating frame may have a first wall portion and a second wall portion disposed opposite to the first wall portion. The first wall portion may include the capping member in a detachable manner, the second wall portion may have a window portion having light transparency disposed facing the capping member, and a drive gear transmitting a drive force from a drive device to a developing device may be provided on the second wall portion in the accommodating frame.

The drive gear is provided at an opposite side of the toner inlet, and it can be prevented from being soiled during toner replenishment.

According to an aspect of the invention, the toner inlet may be greater than the window portion in size.

The toner inlet, which is located on the side where toner is entered, has a wide area for toner refill, thus facilitating operation. On the other hand, the window portion, which is located on the side to which drive gears are attached, has a small area, thus effectively increasing the flexibility in the arrangement of the drive gear.

According to an aspect of the invention, the capping member may be formed from a light-transmissive material. The light-transmissive material may be polycarbonate.

Thus, the capping member can be preferably structured to transmit light.

According to an aspect of the invention, the light transmitting portion of the capping member may be disposed inside from an inner wall surface of the toner storing portion or the light transmitting portion and the inner wall surface of the toner storing portion may be flushed with each other. A wiper that slides on the light-transmitting portion of the capping member may be provided inside the toner storing portion in the accommodating frame.

Thus, the wiper is likely to contact the light-transmitting portion, and dirt on the light-transmitting portion can be cleaned off easily.

Thus, the wiper is not difficult to move between the light-transmitting portion and the inner wall surface of the toner storing portion, and dirt on the light-transmitting portion can be removed easily.

According to an aspect of the invention, the toner inlet may be composed of a cylindrical portion having a cylindrical inner peripheral surface.

The capping member can be held at the inner surface of the cylindrical portion, whereas a replenishment tool (such as a nozzle) can be guided appropriately during toner replenishment. In addition, the distance between the toner storing portion and the external surface of the accommodating frame can be kept to some degree because of the cylindrical portion. Thus, if the capping member is inadequately attached, toner is unlikely to leak.

According to an aspect of the invention, the capping member may include an engaging portion that is inserted into the toner inlet, and a positioning portion that controls the capping member to move to an inside of the accommodating frame.

Thus, the capping member can be positioned stably.

According to an aspect of the invention, a sheetlike bonding medium may be disposed between the positioning portion and an end portion of the cylindrical portion

Thus, the capping member can be effectively prevented from coming off. A gap between the capping member and the toner inlet is filled with the bonding medium, so that the toner leakage can be prevented. As the bonding medium is provided to the end portion, it can be easily removed for recycling.

According to an aspect of the invention, the toner inlet may be composed of a cylindrical portion that protrudes outward from an outside wall surface of the toner storing portion.

Thus, the capping member can be attached stably and the cylindrical portion does not interfere with any parts in the toner storing portion.

According to an aspect of the invention, an image forming apparatus may include a developer unit. The developer unit may include an accommodating frame having a toner storing portion capable of storing toner and a toner inlet communicating with the toner storing portion; and a capping member provided to be detachably attachable to the accommodating frame. The capping member may be attached to the accommodating frame to close the toner inlet and have a light-transmitting portion. The accommodating frame may have a first wall portion and a second wall portion disposed opposite to the first wall portion. The first wall portion may include the capping member in a detachable manner, the second wall portion may have a window portion having light transparency disposed facing the capping member, and a drive gear transmitting a drive force from a drive device to a developing device may be provided on the second wall portion in the accommodating frame. The image forming apparatus may also include a light projecting portion that emits light to detect toner level; and a light receiving portion that receives the light emitted from the light projecting portion via the light transmitting portion or the window portion.

Thus, the toner level can be detected stably with a simple structure.

In yet a further aspect of the invention, the invention may include a method for determining a toner level in a toner cartridge having a toner inlet capped by a capping member, where the method includes emitting light from one side of a toner cartridge and receiving light on a second side of the toner cartridge, the light passing through the capping member.

In some aspects of the present invention, the capping member may be detachable from a toner cartridge. In other aspects, the capping member may not be detachable from the toner cartridge. Where detachable, the capping member may be easily breakable so as to be a single use component needing replacement if toner cartridge is to be refilled. In other aspects of the invention, the capping member may be reusable so as to be reused after the toner cartridge has been refilled. In both of these aspects, the capping member is detachable from the toner cartridge.

### First Embodiment

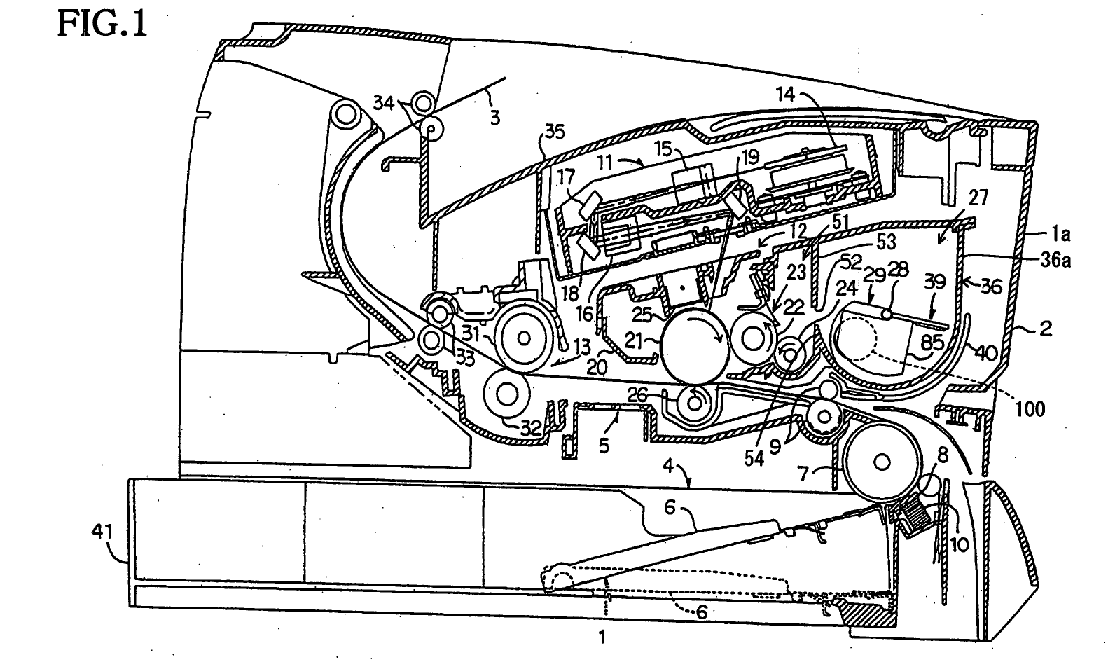

A first embodiment of the invention will be described in detail with reference to FIGS. 1 through 6.

(1. Entire Structure)

In FIG. 1, a laser printer 1 includes, in a main body casing 2, a feeder unit 4 for supplying sheets 3 and an image forming unit 5 for forming a specified image on a sheet 3 supplied.

The feeder unit 4 includes a sheet feed tray 41, a presser plate 6, a sheet feed roller 7, a sheet feed pad 8, and registration rollers 9. The sheet feed tray 41 is detachably attached to a bottom portion of the main body casing 2. The presser plate 6 is provided in the sheet feed tray 41. The sheet feed roller 7 and the sheet feed pad 8 are provided above one end of the sheet feed tray 41. The registration rollers 9 are provided downstream from the sheet feed roller 7 with respect to the sheet conveying direction.

The presser plate 6 allows sheets 3 to be stacked thereon. The presser plate 6 is pivotally supported at its end remote from the sheet feed roller 7 such that the presser plate 6 is vertically movable at its end closest to the sheet feed roller 7. The presser plate 6 is urged upwardly from its reverse, or bottom, side by a spring (not shown). As the stack of sheets 3 increases in quantity, the presser plate 6 swings downwardly about the end of the presser plate 6 remote from the sheet feed roller 7, against the urging force of the spring.

The sheet feed roller 7 and the sheet feed pad 8 are disposed facing each other. The sheet feed pad 8 is urged toward the sheet feed roller 7 by a spring 10 disposed on the reverse side of the sheet feed pad 8. An uppermost sheet 3 in the stack on the presser plate 6 is pressed against the sheet feed roller 7 by a spring 8 (not shown) provided on the reverse side of the presser plate 6, and the uppermost sheet 3 is pinched between the sheet feed roller 7 and the sheet feed pad 8 when the sheet feed roller 7 rotates. Thus, the sheets 3 are fed one by one from the top of the stack.

The registration rollers 9 are composed of two rollers respectively located on a drive side and a driven side, and are used to convey a sheet 3, which is to be conveyed from the sheet feed roller 7, to the image forming unit 5 after the sheet 3 is registered or skew of the sheet is corrected.

The image forming unit 4 includes a scanner unit 11, a process unit 12, and a fixing unit 13.

The scanner unit 11 is provided in an upper portion of the main body casing 2 and has a laser emitting portion (not shown), a rotatable polygonal mirror 14, lenses 15, 16, and reflecting mirrors 17, 18, 19. A laser beam emitted from the laser emitting portion based on predetermined image data sequentially passes through or reflects from the optical elements, that is, the polygonal mirror 14, the lens 15, the reflecting mirrors 17, 18, the lens 16, and the reflecting mirror 19 in order as indicated by a broken line in FIG. 1. The laser beam is thus directed to and scanned at a high speed over the surface of a photosensitive drum 21 of the process unit 12, which will be described later.

The process unit 12 is disposed below the scanner unit 11 so as to be detachably attachable with respect to an apparatus body 1a. In this embodiment, the apparatus body la refers to the whole of the laser printer 1 except for the process cartridge 20. The process unit 12 includes a drum cartridge 20 detachably attached to the main body casing 2, and a developing cartridge 36 detachably attached to the drum cartridge 20. The developing cartridge 36 functions as a developer unit. The drum cartridge 20 includes a photosensitive drum 21, a transfer roller 26, and a scorotron charger 25. Thus, the developing cartridge 36 is structured to be separable from the photosensitive drum 21 and the scorotron charger 25.

The developing cartridge 36 is partitioned into a development chamber 51 for developing toner, and a toner chamber 27 (functioning as a toner storing portion) for storing toner therein. In the development chamber 51, a developing roller 22, a layer-thickness regulating blade 23 as a layer-thickness regulating member, and a supply roller 24 are accommodated.

The development chamber 51 and the toner chamber 27 are partitioned by an upper-side partition wall 53 and a lower-side partition wall 54. Between the upper-side partition wall 53 and the lower-side partition wall 54, a substantially rectangular opening 52 extending in a width direction is formed. The opening 52 is opened so that toner is circulated through the toner chamber 27 and the development chamber 51.

The toner chamber 27 contains positively charged nonmagnetic single-component toner as a developing agent. When positively charged nonmagnetic single-component toner is used, it can be developed on the photosensitive drum 21 positively charged. That is, when negatively charged toner is used, the photosensitive drum 21 needs charging negatively. However, if the photosensitive drum 21 is charged negatively in a non-contact condition using the scorotron charger 25, an abundance of ozone will be generated. In addition, to prevent generation of ozone, if the photosensitive drum 21 is charged in a contact condition using a part such as a conductive roller or brush, it will not be charged evenly. On the other hand, to charge the photosensitive drum 21 positively, even if the scorotron charger 25 is used for non-contact charging, the generation of ozone will be extremely low, and the photosensitive drum 21 can be charged evenly. The toner used in this embodiment is a polymerized toner obtained though copolymerization of styrene-based monomers such as styrene, and acryl-based monomers such as acrylic acid, alkyl(C1-C4)acrylate, and alkyl(C1-C4)methacrylate, using a known polymerization method, such as suspension polymerization. The polymerized toner has styrene-acryl base resin as the main ingredient. A coloring agent, such as carbon black, a charge control agent such as nigrosine, and wax are added to the polymerized toner. An external additive, such as silica, is also added to the polymerized toner. The particle shape of such a polymerized toner is substantially spherical and the average particle size of the toner is approximately 6-10 μm. As such a polymerized toner has particles of a uniform diameter, the particles are shaped close to a sphere, and the polymerized toner has excellent flowability. Thus, the toner in the developing cartridge 36 is efficiently circulated by agitation of an agitator 29, which will be described later, contributing to charging efficiency and high-quality image formation. Agitator 29 may include but not be limited to the agitator 29 and related components of U.S. Pat. No, 6,337,956, whose contents are expressly incorporated herein by reference.

The photosensitive drum 21 is disposed at a side of the developing roller 22 so as to rotate in a direction of an arrow (clockwise direction) in contact with the developing roller 22. The photosensitive drum 21 is structured that the drum body is grounded and its surface is formed of a positively chargeable material such as an organic photoconductor that is predominantly composed of polycarbonate.

The scorotron charger 25 is disposed above the photosensitive drum 21 at a predetermined distance therefrom. The scorotron charger 25 is a positive scorotron charger that produces corona discharge from a charging wire such as a tungsten wire, and is designed to positively charge the surface of the photosensitive drum 21 uniformly.

The surface of the photosensitive drum 21 is positively and uniformly charged by the scorotron charger 25, and then is exposed by the high-speed scanning of the laser beam from the scanner unit 11. An electrostatic latent image based on specified image data is formed on the surface of the photosensitive drum 21. Upon the rotation of the developing roller 22, toner carried by the developing roller 22 and positively charged is selectively transferred onto an electrostatic latent image formed on the surface of the photosensitive drum 21, that is lower-potential areas of the of the photosensitive drum 21 that have been exposed to the laser beam. Thus, the electrostatic latent image becomes visible and thus development (reversal development) is accomplished.

A transfer roller 26 is disposed below the photosensitive drum 21 to face the photosensitive drum 21 and rotate in a direction of an arrow (counterclockwise direction). The transfer roller 26 is formed by covering a metallic roller shaft with a roller made of a conductive rubber material and a specified transfer bias is applied to the transfer roller 26. Thus, toner developed on the photosensitive drum 21 is transferred onto a sheet 3 while the sheet 3 passes between the photosensitive drum 21 and the transfer roller 26.

As shown in FIG. 1, a fixing unit 13 is disposed at a downstream side of the process unit 12. The fixing unit 13 includes a heat roller 32, a pressure roller 31 which is pressed by the heat roller 32, and a pair of conveying rollers 33 which are provided downstream of the heat roller 32 and the pressure roller 31. The heat roller 32 is provided with a halogen lamp made of metal and intended for heat-up. In the process unit 12, the toner transferred onto the sheet 3 is fixed by heat while the sheet 3 passes between the heat roller 32 and the pressure roller 31, and the sheet 3 is conveyed by the conveying rollers 33 to a pair of ejection rollers 34. The sheet 3 conveyed to the ejection rollers 34 is ejected onto an output tray 35 by the ejection rollers 34.

The laser printer 1 is designed to use a cleaner-less method to collect toner remaining on the photosensitive drum 21 after visible image is transferred. In the cleaner-less method, upon the rotation of the photosensitive drum 21, the toner remaining on the photosensitive drum 21 after the visible image is transferred is brought to face the scorotron charger 25, so as to be positively charged uniformly by the scorotron charger 25. Then, upon the rotation of the photosensitive roller 21, the toner remaining on the photosensitive drum 21 is brought to face the developing roller 22 and is collected by the developing roller 22 to which a developing bias is applied.

(2. Internal Structure of Developing Cartridge)

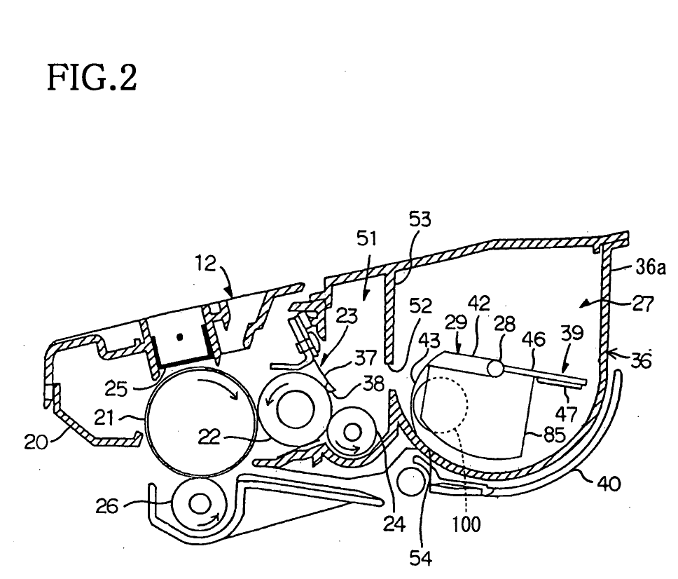

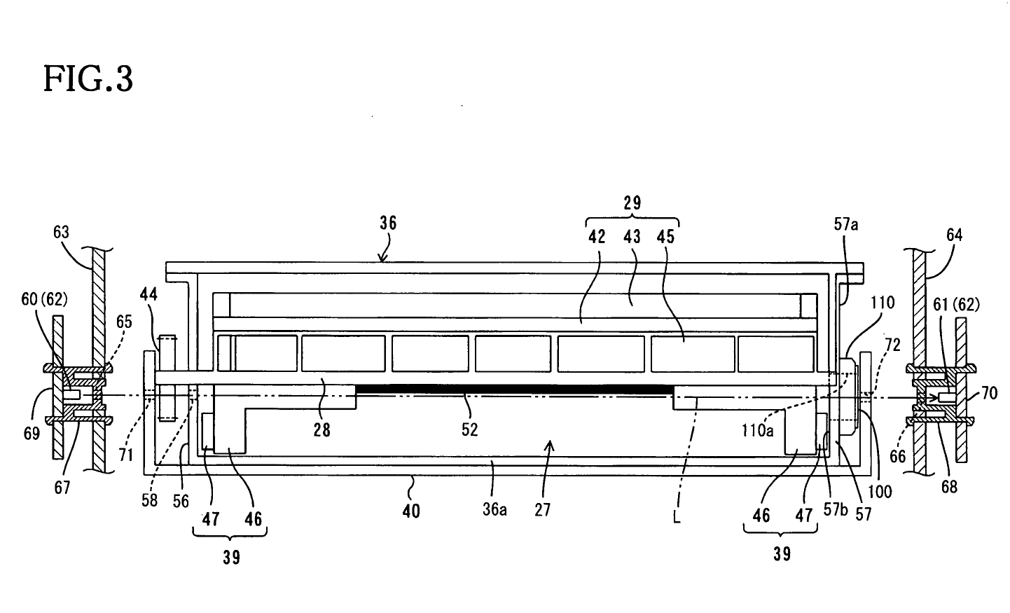

An internal structure of the developing cartridge will be described with reference to FIGS. 2 and 3. FIG. 2 shows the process unit 12 in an enlarged view. FIG. 3 is a cross sectional view, showing the inside of the toner chamber 27. In FIG. 3, to simplify the description, the agitator 29 and wipers 39 are shown so as to extend in a vertical direction (in a direction parallel to the upper-side partition wall 53), not shown in positions shown in FIG. 2.

As shown in FIGS. 2 and 3, the toner chamber 27 is provided with the agitator 29 for agitating ink to supply it from the opening 52 to the development chamber 51, the wipers 39 for cleaning a window portion 58 and a capping member 100, and a rotating shaft 28 that supports the agitator 29 and the wipers 39.

The rotating shaft 28 extends to opposite side walls (a first sidewall 57 and a second sidewall 56) of the toner chamber 27 in substantially a central portion of the toner chamber 27, and protrudes from the second sidewall 56 of the toner chamber 27 at its one end. A rotating shaft gear 44 is provided at the end where the shaft protrudes, to drive and rotate the rotating shaft 28. The first sidewall 57 functions as a first wall portion and the second sidewall 56 functions as a second wall portion.

As shown in FIG. 3, capping member 100 is shown relative to first sidewall 57 while rotating shaft gear 44 is shown relative to second sidewall 56. In an alternative aspect, capping member 100 may be located on the same sidewall as rotating shaft gear 44. Having capping member 100 (and toner inlet 110) on a side removed from rotating shaft gear 44 may help prevent toner from accumulating, fouling, and/or interfering with the rotating shaft gear 44. On the other hand, having capping member 100 (and toner inlet 110) on the same side as rotating shaft gear 44 may ease manufacturing and/or provide for a larger volume toner chamber 27.

The agitator 29 is provided to the rotating shaft 28 along the length thereof, as shown in FIGS. 2 and 3. The agitator 29 includes a supporting member 42 and a sliding contact member 43. The supporting member 42 is made of a resin and extends from the rotating shaft 28 radially outwardly. The sliding contact member 43 is attached to the end of the supporting member 42 and shaped in a film made of such as polyethylene terephthalate.

The agitator 29 is rotated in the toner chamber 27 upon the rotation of the rotating shaft 28, and the sliding contact member 43 slides on the bottom surface of the toner chamber 27 formed in substantially a cylindrical shape in a bent condition, pushes up the toner and ejects it to the development chamber 51 from the opening 52.

During rotation of the agitator 29, as the supporting member 42 pushes up the toner as well as the sliding contact member 43, it receives great resistance. However, to reduce the resistance due to the toner, the supporting member 42 is formed with openings 45 provided at regular intervals in its longitudinal direction.

The wipers 39 are provided on both sides of the rotating shaft 28 with respect to its longitudinal direction so as to be located 180 degrees apart with respect to the agitator 29. The wipers 39 include supporting members 46 and cleaning members 47. The supporting members 46 are made of a resin and extend outwardly radially from the rotating shaft 28, and the cleaning members 47 are made of a urethane rubber and provided at outward ends of the supporting members 46.

The wipers 39 are rotated in the toner chamber 27 upon the rotation of the rotating shaft 28. With the rotation of the wipers 39, each cleaning member 47 contacts the window portion 58 and the capping member 100 to wipe toner adhered on inside surfaces of the window portion 58 and the capping member 100 in the chamber. As the agitator 29 and the wipers 39 are supported by the rotating shaft 28, the window portion 58 and the capping member 100 are cleaned by the wipers 39 in a cycle of the rotation of the agitator 29 regardless of the rotating speed of the agitator 29. Thus, the toner level can be detected by toner detection optical sensors 62 precisely and reliably.

As shown in FIG. 2, the agitator 29 includes a light-shielding plate 85 having substantially a sector shape. With the light-shielding plate 85, the time to shield light of the toner detection optical sensors 62 in one rotation of the agitator 29 can be defined longer to reduce improper detection, so that more accurate detection can be accomplished.

On the other hand, the supply roller 24 is disposed close to the opening 52 in the development chamber 51 so as to rotate in a direction of an arrow (counterclockwise direction) in FIG. 2. The developing roller 22 is disposed facing the supply roller 24 so as to rotate in a direction of an arrow (counterclockwise direction). The supply roller 24 and the developing roller 22 are pressed in contact with each other to be compressed to some degree.

The supply roller 24 is formed by covering a metallic roller shaft with a roller made of a conductive foaming material. The developing roller 22 is formed by covering a metallic roller shaft with a roller made of a conductive rubber material. More specifically, the roller of the developing roller 22 is made of urethane or silicone rubber including carbon fine particles covered with a coat of a urethane or silicone rubber including fluorine. In this way, as the surface of the developing roller 22 is covered with the coat of the urethane or silicone rubber including fluorine with negative charge polarity, positive charge polarity of the toner held on the surface can be improved. A specified developing bias to make a potential difference with the photosensitive drum 21 is applied to the developing roller 22.

The layer-thickness regulating blade 23 is disposed near the developing roller 22. The layer-thickness regulating blade 23 includes a blade body 37 and a pressing member 38. The blade body 37 is made of a metallic leaf spring member. The pressing member 38, shaped in a semicircle, is provided at an end portion of the blade body 37 and made of a silicone rubber having insulating ability. The layer-thickness regulating blade 23 is structured so that an end portion of the blade body 37, which is opposite the pressing member 38, is supported by a frame 36a (functioning as an accommodating frame) of the developing cartridge 36 near the developing roller 22, and the pressing member 38 is pressed into contact with the developing roller 22 by elastic force of the blade body 37.

The toner released from the opening 52 to the development chamber 51 is supplied to the developing roller 22 upon the rotation of the supply roller 24, and simultaneously positively charged by friction between the supply roller 24 and the developing roller 22. The toner supplied onto the developing roller 22 goes between the pressing portion 38 of the layer-thickness regulating blade 23 and the developing roller 22 upon the rotation of the developing roller 22. The toner is rubbed and fully charged by friction between the pressing portion 38 and the developing roller 22, and is held on the developing roller 22 as a thin layer having a substantially uniform thickness.

(3. Structure for Detecting Toner Level)

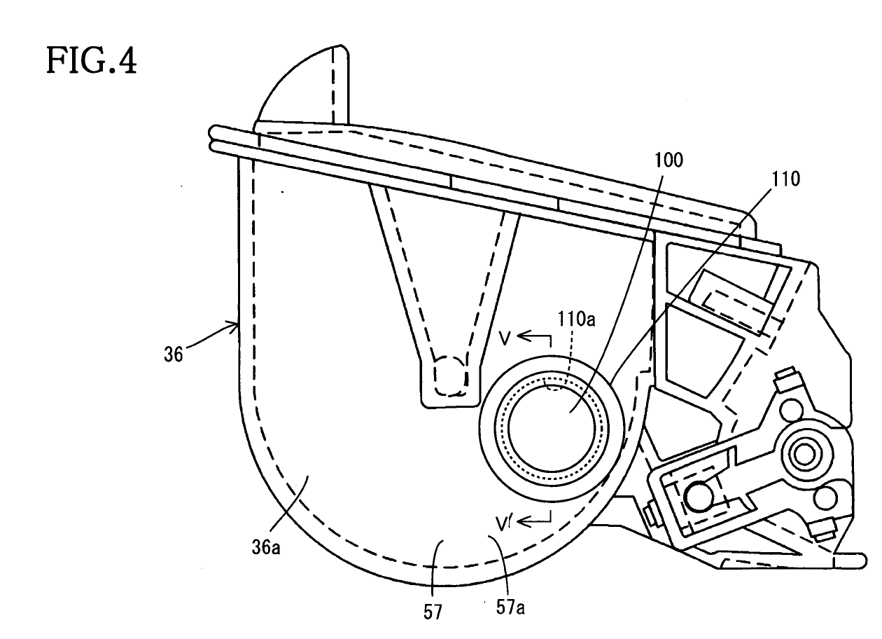

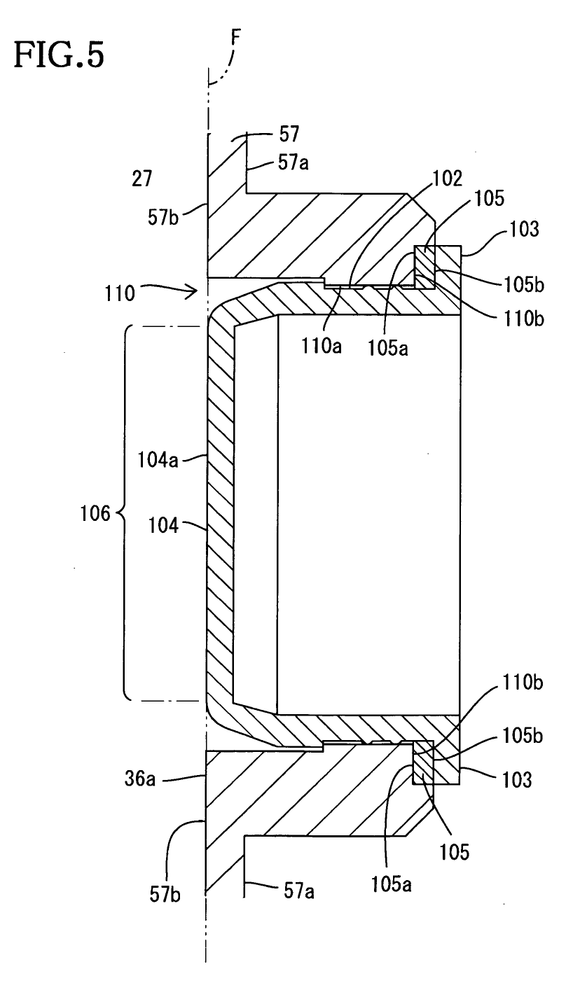

A structure for detecting the toner level in the developing cartridge 36 will be described. FIG. 4 is a side view of the developing cartridge 36 viewed from a toner inlet side. FIG. 5 is a cross sectional view of the neighborhood of the toner inlet taken along the line V-V of FIG. 4. As shown in FIG. 3, the frame 36a of the developing cartridge 36 is formed with the toner chamber 27 for storing toner, and a toner inlet 110 that communicates with the toner chamber 27 and is intended for entering toner.

As shown in FIGS. 3 and 4, the frame 36a of the developing cartridge 36 is formed with the first sidewall 57 and the second sidewall 56 which are disposed facing each other. The toner inlet 110 is formed at the first sidewall 57 to include a cylindrical inner peripheral surface 110a and is structured as a protruding cylindrical portion that protrudes outward further than an outside wall surface 57a of the first sidewall 57 (that is, an outside wall surface of the toner chamber 27).

As shown in FIG. 5, the capping member 100 is detachably attachable with respect to the toner chamber 27. Specifically, the capping member 100 is detachably provided at the first sidewall 57 where the toner inlet 110 is provided to seal the toner inlet 110.

The capping member 100 is provided with a light-transmitting portion 106 through which light transmits to detect the toner level. The light-transmitting portion 106 is designed to allow light from the toner detection optical sensors 62 (FIG. 3) to transmit. In this embodiment, the entire capping member 100 has transparency. When the capping member 100 is attached, a wall portion 104 that faces the inside of the toner chamber 27 serves as the light-transmitting portion 106, and allows the light to transmit in a direction of its thickness. With this structure, the capping member 100 functions not only as a member for sealing the toner inlet 110 but also as a window for detecting the toner level. This structure enables a shared use of a light-transmitting part for detecting the toner level and a removable part for entering toner in a single part. In addition, the frame 36a does not need working in each time to realize functions (such as a function of a toner refill, and a function to detect the toner level). Thus, space for layout can be omitted, the number of parts can be reduced and the facilitation of manufacture can be effectively achieved. In addition, the capping member 100 is composed of polycarbonate. It may be composed of other resin material capable of allowing light to transmit or a glass material.

Further, in this embodiment, the capping member 100 can be held stably with the provision of the cylindrical inner peripheral surface 110a, while, in the case of a toner refill, it is capable of guiding a tool for refill (such as a nozzle) accurately. As the toner inlet 110 is formed in a cylindrical shape, the distance from the toner chamber 27 to the external can be kept to some degree. Thus, if the capping member 100 is inadequately attached, toner is unlikely to leak.

As shown in FIG. 5, the capping member 100 has an engaging portion 102 to be inserted into the toner inlet 110, and a positioning portion 103 so as to be supported by an end portion 110b of the toner inlet 110 provided on a side to which the capping member 100 is inserted. The positioning portion 103 is supported by the end portion 110b to control the capping member 100 to move to the inside of the frame 36a.

A sheetlike bonding medium 105 is provided between the positioning member 103 and the end portion 110b of the toner inlet 110. The bonding medium 105 is composed of a double-faced tape in which a face 105a facing the end portion 110b and a face 105b facing the positioning portion 103 are disclosed as bonding portions. The bonding medium 105 is annularly disposed around the capping member 100 so as to bond the positioning portion 103 and the end portion 110b. Thus, the capping member 100 can be prevented from coming off. The gap between the capping member 100 and the toner inlet 110 is filled with the bonding medium 105, so that the toner leakage can be prevented. As the bonding medium 105 is provided to the end portion 110b, it can be easily removed for recycling.

As shown in FIG. 3, the window portion 58 having light transparency is provided on a sidewall opposite to the capping member 100 (that is, on the second sidewall 56) so as to face the capping member 100. The window portion 58 includes an opening portion formed in the second sidewall 56 and a resin member having light transparency to block the opening portion (in other words, the opening portion formed in the second sidewall 56 is closed by the resin member). The resin member is configured such that it is difficult to be detachably attached to the second sidewall 56.

In the embodiment, the toner inlet 110 is configured larger than the window portion 58 in size, and has a wide area for toner refill, thus facilitating operation. On the other hand, the window portion 58, which is located on the side to which drive gears are attached, has a small area, thus effectively increasing the flexibility in the arrangement of the drive gears.

As shown in FIG. 5, the light-transmitting portion 106 and an inner wall surface 57b of the first sidewall 57 (or an inner wall surface of the toner chamber 27) are structured so that they are flush with each other. Specifically, an inside face 104 of the light-transmitting portion 106 and the inner wall surface 57b of the first sidewall 57 are provide on an identical phantom plane F.

In other words, as described above, the cleaning member 47 is provided inside the toner chamber 27 in the frame 36a so as to slide in contact with the light-transmitting portion 106 of the capping member 100. However, in the embodiment, the cleaning member 47 is not difficult to move between the light-transmitting portion 106 and the inner wall surface 57b of the first sidewall 57, and dirt on the light-transmitting portion 106 can be removed easily.

As shown in FIG. 3, the apparatus body la of the laser printer 1 is provided with the toner detection optical sensors 62 for detecting the toner level remaining in the toner chamber 27. The toner detection optical sensors 62 include a light projecting portion 60 having a light emitting device and projecting light for detecting the toner level, and a light receiving portion 61 having a light-receptive device and receiving the light from the light projecting portion 60. The light from the light projecting portion 60 to the light receiving portion 61 is conceptually indicated by a double-dotted line L.

Namely, in FIG. 3, the window portion 58 and the capping member 100 are provided on both sidewalls 56, 57 of the toner camber 27, respectively, so that they can face to each other at positions closer to the opening 52 than the center of the toner chamber 27. The light projecting portion 60 and the light receiving portion 61 are attached to flames 63, 64 of the main body casing 2, which face the window portion 58 and the capping member 100, respectively.

Specifically, a lens 65 is embedded in the frame 63 facing the window portion 58, a support substrate 69 is supported via a holder member 67 at a position outwardly facing the lens 65, and the light projecting portion 60 is provided on the support substrate 69 so that the light emitting device faces the lens 65. A lens 66 is embedded in the frame 64 facing the capping member 100. A support substrate 70 is supported via a holder member 68 at a position outwardly facing the lens 66. The light receiving portion 61 is provided on the support substrate 70 so that the light receiving device faces to the lens 66.

In FIG. 3, a case portion 40 of the drum cartridge 20 is shown in substantially a recessed state so as to enclose a lower side of the developing cartridge 36. Opening portions 71, 72 are formed on both sidewalls of the case portion 40 facing the window portion 58 and the capping member 100.

Thus, the light projecting portion 60, the lens 65, the opening 71, the window portion 58, the light receiving portion 61, the lens 66, the opening portion 72, and the capping member 100 are arranged in a line across the toner chamber 27. With this arrangement, light having strong directivity (such as a laser beam), which is emitted from the light projecting portion 60, passes through the toner chamber 27 via the lens 65, the opening 71 and the window portion 58, and is received by the light receiving portion 61 via the capping member 100, the opening 72 and the lens 66.

At the light receiving portion 61, a voltage outputted from the light receiving device varies according to the amount of the received light. If the amount of the received light is low, the output voltage is high (5V for example), and if the amount is high, the output voltage is low (0V for example). Thus, the change of the output voltage is detected so that it is possible to detect whether light passing through the toner chamber 27 is blocked by the toner remaining.

According to the toner detection optical sensors 62, when toner fully remains in the toner chamber 27, light connecting the light projecting portion 60 and the light receiving portion 61 is blocked by the toner, so that it is possible to detect that there is no need to supply toner yet, properly and reliably. When the toner gets low in the toner chamber 27 or no toner exists, the light connecting the light projecting portion 60 and the light receiving portion 61 is not blocked by the toner, so that it is possible to detect that toner needs replenishing, properly and reliably.

(4. Drive system)

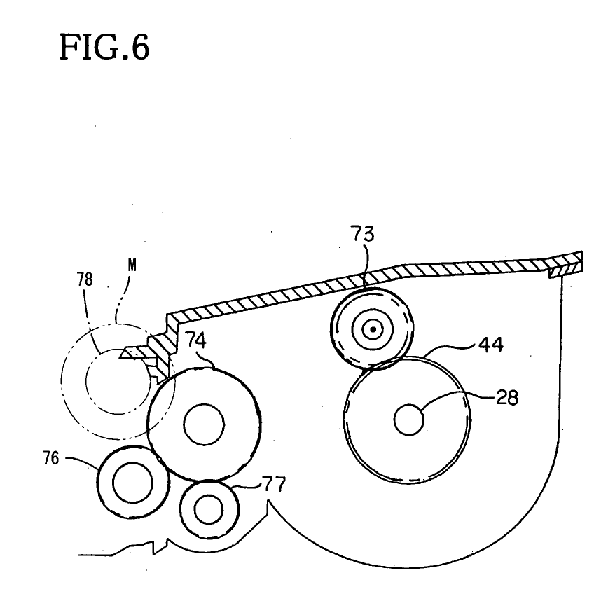

FIG. 6 schematically shows a drive system of the developing cartridge 36. In FIG. 6, the developing cartridge 36 includes an agitator-side input gear 73 and a developing roller-side input gear 74, which both serve as input gears to which a drive from the main casing 2 is transmitted. The agitator-side input gear 73 is provided on a side of the toner chamber 27 with respect to its width. The developing roller-side input gear 74 is provided on a side of the development chamber 51 with respect to its width. A drive system of the agitator 29 and a drive system of the developing roller 22 are not connected in the developing cartridge 36. They are independently structured. The developing roller-side input gear 74 functions as a drive gear.

The agitator-side input gear 73 is configured to mesh with a rotating shaft gear 44 provided around the rotating shaft 28, and to receive transmission of a drive from a sub motor (not shown) provided in the main casing 2 when the developing cartridge 36 is attached to the main casing 2. Thus, the drive from the sub motor is transmitted via the agitator-side input gear 73 to the rotating shaft gear 44, the rotating shaft gear 44 is driven, the rotating shaft 28 is rotated, and then the agitator 29 and the wipers 39 are rotated in the toner chamber 27.

The developing roller-side input gear 74 is configured to mesh with a developing roller gear 76, which is provided around the roller shaft of the developing roller 22 at a side of the development chamber 51 with respect to its width, and the a supply roller gear 77, which is provided around the roller shaft of the supply roller 24 at the side of the development chamber 51. The developing roller-side input gar 74 is also configured to mesh with a transmission gear 78 (shown by a double-dotted line) when the developing roller 36 is attached to the main casing 2, and to receive transmission of a drive from a main motor M (shown by a double-dotted line) provided in the main casing 2. Specifically, the drive from the main motor M is transmitted to the developing roller-side input gear 74 via the transmission gear 78 interlocking with the main motor M, and further to the developing roller gear 76 and the supply roller gear 77 respectively. When the developing roller gear 76 and the supply roller gear 77 are driven, the developing roller 22 and the supply roller 24 are rotated independently.

The drive from the main motor M is used to drive rollers such as the photosensitive drum 21, the transfer roller 26, and the heat roller 32, as well as the developing roller-side input gear 74. The drive from the sub motor is used to drive the agitator-side input gear 73 only.

In the embodiment, the developing roller-side input gear 74 that is designed to transmit the driving force from the driving device (the main motor M) to the developing roller 22 is provided on the second sidewall 56 in the frame 36a. In other words, as the gears are located on a side opposite to the toner inlet 100, they will not become soiled with toner during toner replenishment. In addition, the window portion 58, which is smaller than the toner inlet 100, is located on the second sidewall 56 opposite the toner inlet 100, thus effectively increasing the flexibility in the arrangement of the gears such as the developing roller-side input gear 74.

### Second Embodiment

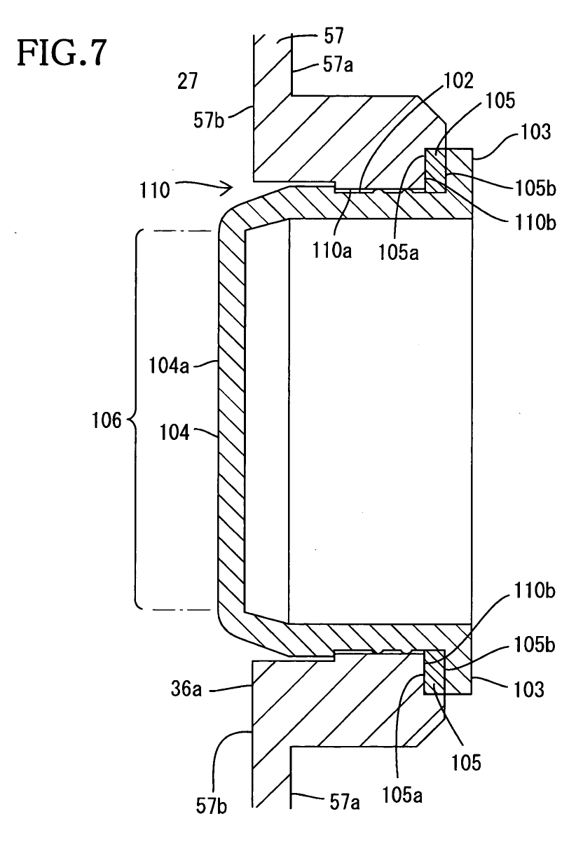

A second embodiment of the invention will be described with reference to FIG. 7. FIG. 7 shows a toner inlet of an image forming apparatus according to the second embodiment, which is a modification of the capping member shown in FIG. 5. In this embodiment, the light-transmitting portion 106 of the capping member 100 is disposed more inside than the inner wall surface of the toner chamber 27 (the inner wall surface 57b of the first sidewall 57), which is different from the first embodiment. It is noted that elements similar to or identical with those in the first embodiment are designated by similar numerals, and thus the description thereof is omitted for the sake of brevity. In this embodiment also, a wiper, which is similar to that of the first embodiment and slides on the light-transmitting portion 106 of the capping member 100, is provided inside the toner chamber 27 in the frame 36a. Such a cleaning member is more likely to contact the light-transmitting portion 106, so that dirt on the light-transmitting portion 106 can be cleaned off easily.

### Other Embodiments

In the above embodiment, a developer unit is structured of the developing cartridge 36. However, a process unit including an image holding member may be structured as a developer unit. For example, a frame including a toner chamber and a drum cartridge may be formed in one unit as a developer unit, without the frame including the toner chamber being detachable to the drum cartridge.

In the above embodiment, the developer unit is structured to be detachably attachable to the apparatus body la, but it is not limited to this. The developer unit may be structured so that the toner chamber for storing toner may be fixed to the main casing.

In the above embodiment, the drive system of the agitator 29 and the drive system of the developing roller 22 are not linked in the developing cartridge 36, and are structured independently of each other. However, they may be combined into one drive system. For example, the developing roller 22 and the agitator 29 may be configured to be driven together by the driving force from a single drive unit (e.g. a main motor). In this case, the single drive unit may function as a drive unit.

While the various aspects of the invention have been described in conjunction with the illustrative aspects outlined above, various alternatives, modifications, variations, improvements and/or substantial equivalents, whether known or that are or may be presently unforeseen, may become apparent to those having at least ordinary skill in the art. Accordingly, the illustrative aspects of the invention, as set forth above, are intended to be illustrative, not limiting. Various changes may be made without departing from the spirit and scope of the invention. Therefore, the invention is intended to embrace all known or later developed alternatives, modifications, variations, improvements and/or substantial equivalents.

What is claimed is:

1. A developer unit comprising:
an accommodating flame having a toner storing portion capable of storing toner and a toner inlet communicating with the toner storing portion; and
a capping member attached to the accommodating frame to close the toner inlet and said capping member having a light-transmitting portion.

2. The developer unit according to claim 1, wherein the capping member is detachable.

3. The developer unit according to claim 2, wherein the capping member is reusable.

4. The developer unit according to claim 2, wherein the capping member is not reusable.

5. The developer unit according to claim 1, wherein the accommodating frame has a first wall portion and a second wall portion disposed opposite to the first wall portion, the first wall portion includes the capping member in a detachable manner, the second wall portion has a window portion having light transparency disposed facing the capping member, and a drive gear transmitting a drive force from a drive device to a developing device is provided on at least one of the first wall portion and the second wall portion in the accommodating frame.

6. The developer unit according to claim 5, wherein said capping member and said drive gear are on the same wall portion.

7. The developer unit according to claim 5, wherein said capping member and said drive gear are on said first wall portion and said second wall portion, respectively.

8. The developer unit according to claim 5, wherein the toner inlet is greater than the window portion in size.

9. The developer unit according to claim 1, wherein the capping member is formed from a light-transmissive material.

10. The developer unit according to claim 9, wherein the light-transmissive material is polycarbonate.

11. The developer unit according to claim 1, wherein the light transmitting portion of the capping member is disposed inside from an inner wall surface of the toner storing portion or the light transmitting portion and the inner wall surface of the toner storing portion are flush with each other.

12. The developer unit according to claim 11, wherein a wiper that slides on the light-transmitting portion of the capping member is provided inside the toner storing portion in the accommodating frame.

13. The developer unit according to claim 12, wherein the wiper rotates integrally with an agitator.

14. The developer unit according to claim 1, wherein the toner inlet includes a cylindrical portion having a cylindrical inner peripheral surface.

15. The developer unit according to claim 14, wherein the capping member includes an engaging portion that is inserted into the toner inlet, and a positioning portion that controls the capping member to move to an inside of the accommodating frame.

16. The developer unit according to claim 15, wherein a sheet-like bonding medium is disposed between the positioning portion and an end portion of the cylindrical portion.

17. The developer unit according to claim 16, wherein the toner inlet includes a cylindrical portion that protrudes outward from an outside wall surface of the toner storing portion.

18. An image forming apparatus comprising:
a developer unit including
an accommodating frame having a toner storing portion capable of storing toner and a toner inlet communicating with the toner storing portion; and
a capping member provided to be detachably attachable to the accommodating frame, the capping member attached to the accommodating frame to close the toner inlet and having a light-transmitting portion, and wherein the accommodating frame has a first wall portion and a second wall portion disposed opposite to the first wall portion, the first wall portion includes the capping member in a detachable manner, the second wall portion has a window portion having light transparency disposed facing the capping member, and a drive gear transmitting a drive force from a drive device to a developing device is provided on at least one of the first wall portion and the second wall portion in the accommodating frame; and
a light projecting portion that emits light to detect toner level; and
a light receiving portion that receives the light emitted from the light projecting portion via the light transmitting portion or the window portion.

19. The image forming apparatus according to claim 18, wherein said capping member is detachable.

20. The image forming apparatus according to claim 19, wherein said capping member is reusable.

21. The image forming apparatus according to claim 19, wherein said capping member is not reusable.

22. The image forming apparatus according to claim 18, wherein the drive gear is provided on the second wall portion.

23. The image forming apparatus according to claim 18, wherein the drive gear is provided on the first wall portion.

24. An image forming apparatus comprising:
a toner detection optical sensor;
an accommodating frame having a toner storing portion capable of storing toner and a toner inlet communicating with the toner storing portion; and
a capping member provided to be detachably attachable to the accommodating frame and attached to the accommodating frame to close the toner inlet; and
wherein the capping member has a light-transmitting portion through which light is transmitted.

25. The image forming apparatus according to claim 24, wherein said capping member is detachable.

26. The image forming apparatus according to claim 25, wherein said capping member is reusable.

27. The image forming apparatus according to claim 25, wherein said capping member is not reusable.
